(19) United States
(12) Patent Application Publication
(10) Pub. No.: US 2007/0009102 A1
(43) Pub. Date: Jan. 11, 2007

(54) Secure keystream transmission methods for wireless communication systems

(76) Inventors: Weibo Gong, Amherst, MA (US); David M. Pozar, Leverett, MA (US)

Correspondence Address: Weibo Gong, 25 Sacco Drive, Amherst, MA, 01002, US

(21) Appl. No.: 11/175,592

(22) Filed: Jul. 7, 2005

(51) Int. Cl. H04K 1/00

(52) U.S. Cl. 380/270

(57) ABSTRACT

The present invention relates generally to security in wireless data transmission, and, more particularly, to highly secure methods for transmitting keystreams among authorized communication nodes in wireless networks where all authorized communication nodes have to register in the network management system to warrant communication services. The securely transmitted keystreams can be used for many cryptographic applications, including everlasting encryption that can protect against realtime or non realtime cryptanalysis by eavesdroppers.

### CROSS-REFERENCE TO RELATED APPLICATIONS

This application is entitled to the benefit of Provisional Patent Application Ser. No. 60/585,706, filed Jul. 06, 2004.

### STATEMENT REGARDING FED SPONSORED R&D

Not Applicable.

### BACKGROUND

1. Field of Intention

The present invention relates generally to security in wireless data transmission, and, more particularly, to highly secure methods for transmitting keystreams among authorized communication nodes in wireless networks. Suitable implementations of the methods described in the present invention will provide better privacy in wireless networks against silent eavesdroppers than current techniques in wired network counterparts.

2. Discussion of Priori Art

In recent years, wireless networks, in particular Wireless Local Area Networks (WLANs), have become a significant technology in government and enterprise networks, public networks and home networks. Their high data rates and convenience of use enable the deployment of increasingly powerful mobile computing and communications devices. As a result, the use of wireless networks and the proliferation of devices adapted for operation in such networks continues to accelerate.

Wireless communications offer organizations and users many benefits such as portability and flexibility, increased productivity, and lower installation costs. Wireless technologies cover a broad range of capabilities oriented toward different applications and needs. Wireless local area network devices, for instance, allow users to move their laptop computers from place to place within their office or building environment without the need for wires and without losing network connectivity. Less wiring means greater flexibility and efficiency, and reduced infrastructure costs. Risks are inherent, however, in any wireless technology. Some of these risks are similar to those of wired networks; some are exacerbated by wireless connectivity; and some are new. The most significant difference from wired networks, and the main source of these risks, is that with wireless networks the underlying communications medium, radio wave transmission, is openly exposed to intruders, making it the logical equivalent of a wired Ethernet port available to the public at large.

At present, there are various methods and protocols for protecting the privacy of data transmitted over wireless communication channels. Various examples of wireless network security methods are set forth in U.S. Pat. Nos. 6,728,378; 6,725,050; 6,650,616; 6,611,913; 6,574,455; 6445,794; 6,330,333; 5,371,794 and some of the references therein. Nevertheless, wireless communication is usually considered to be less secure than its wired counterpart due to the fact that the encrypted text, henceforth referred to as cipher text, is readily available to eavesdroppers having wireless networking equipment in the region of the wireless network. Although great efforts have been devoted to developing sophisticated encryption algorithms that may be very hard to decrypt without the knowledge of the encryption key, non real-time cryptanalysis by an adversary remains a serious threat. Non real-time cryptanalysis means that the eavesdropper (adversary) intercepts the cipher text first, and then uses other means to obtain the encryption key(s) to decrypt the stored cipher text at a later time. These “other means” include stealing discarded computers, “social engineering”, keystroke logging, spying, applying newly available key cracking algorithms or devices, buying the keys from disgruntled employees, and so on. Such threats are less serious for wired networks since it takes a more physically noticeable effort to carry out the eavesdropping. One of the aspects of the present invention is aimed at countering such threats for wireless networks. The methods described in the present invention not only provide highly secure and efficient ways to transmit keystreams for ordinary privacy requirements, they can also be used to support the “everlasting secrecy” encryption developed in [Maurer92, ADR02]. A brief discussion of everlasting encryption is presented here to help describe this aspect of the present invention.

Secure transmission against eavesdropping is an essential goal of cryptography. Specifically, a sender Alice wants to send a message to a receiver Bob in a way that prevents an eavesdropper Eve from learning the message content. Most current encryption technologies rely on the assumptions that (1) Eve never has the encryption key, and (2) Eve has only bounded computing power. Both assumptions may be invalid in the non realtime cryptanalysis scenario described above. In other words, these techniques do not have the everlasting secrecy property [ADR02]. Recent research on everlasting encryption theory provides a theoretical analysis for a bounded-storage model. In such a model one assumes that the adversary has unbounded computation power, but bounded storage. Assume Alice and Bob share a short private key beforehand (for example, via a public key encryption). Then a long public random binary bit sequence X is generated, say broadcast from a satellite, or sent by Alice, which is accessible by all parties. Eve has limited storage, so only some partial information about X can be stored. For the protocol to be efficient, Alice and Bob should require much less storage than the bound placed on Eve. Alice and Bob sample the bit sequence X using the shared private key on the fly, and compute a one-time pad Z. Then Alice encrypts her message M as C, where C is a bitwise modulo 2 sum of M and Z, and sends the encrypted text C to Bob. When X is sent, Eve computes and stores some partial segment of X, hoping later to recover message M after eavesdropping the cipher text C. In this setting, Aumann, Ding, and Rabin [ADR02] gave protocols, improving those of Maurer [Maurer92], which enjoy a provable property called everlasting security. This is an information-theoretical security property that guarantees secrecy for Alice and Bob even if Eve later (after the transmission) manages to obtain the private key from which the one-time pad Z has been derived from the random bitstream X. As mentioned before, the private key can actually be sent via today's public-key encryption methods. The everlasting security protocol guarantees that even if Eve later obtains that private key after the transmission of X, say by breaking the public-key encryption, or by any social engineering method, the message M will still remain information-theoretically secure because the one-time pad Z cannot be recovered. Such a feature is attractive, as the security is guaranteed by the limitation of current storage technology, and will not be affected by future advances of any kind. This is possible because some crucial information of the random bitstream X has been lost forever.

These previous works critically depend on the storage limit of the eavesdropper and the very high speed of the random bit sequence source to transmit the random bits to all users. These requirements are not realistic for most wireless networks, including wireless local area networks, where transmission rates are limited. To prevent silent eavesdroppers from obtaining an exact copy of the random bit sequence (henceforth referred as the keystream) received by the authorized nodes in wireless networks one needs to develop other methods. The present invention provides such methods based on combinations of techniques in wireless transmission, antenna radiation pattern design, network management, reliable data link design, error detecting coding, and others.

### SUMMARY OF THE INVENTION

In one aspect of the invention, a wireless communication network is equipped with a keystream source that delivers high quality encryption keystream data to all receivers in the network. Such keystreams include real random numbers generated from stochastic physical processes, high quality conventional cryptography sequences, or combinations of them.

In another aspect of the present invention, the wireless communication network is equipped with a Channel Randomization System (CRS). The purpose of the CRS is to ensure that when the receivers are receiving the keystream from the keystream sources such as the Wireless Access Point (WAP), the receivers at different locations will receive signals with bit errors at different times.

A further aspect of the present invention provides methods for designing the Channel Randomization System (CRS) with methods for the calculation of the excitation and switching requirements for the CRS antennas.

Another aspect of the present invention provides methods for transmitting correct keystream frames to authorized receivers only, thus ensuring that only authorized receivers have the ability to accurately construct a one-time pad or other forms of encryption keys.

In a further aspect of the invention, to provide a physical layer basis for a management system that coordinates the channel randomization system with the network operation for the adaptive trade-off between security needs and network efficiency.

In a further aspect of the invention, to provide synchronized random bit sequences among multiple authorized users, and authorized users only, for secure communications between or among them and for applications other than encrypted communications.

These and other aspects of the invention will next be described in connection with the attached drawings, taken in combination with the following detailed description of the invention.

### BRIEF DESCRIPTION OF THE DRAWINGS

FIG. 1 is a schematic diagram depicting the scenario for the sender Alice (denoted as A) sending a cipher text via a wireless communication network to the intended receiver Bob (denoted as B), with Eve (denoted as E) silently recording the wireless transmission activities at the same time. A Channel Randomization System (CRS) with two sets of antenna arrays and a CRS controller are depicted.

FIG. 2 shows an example of azimuth radiation patterns for two different excitations for the CRS. It shows the azimuthal radiation patterns for a four-element array of vertical antennas, spaced evenly along a circle with a radius of 1.5 wavelengths. This plot shows the resulting azimuthal radiation pattern for two excitation states. The solid curve is the pattern for a phase offset resulting in a lobe at 6°, while the dotted pattern is for a phase offset resulting in a lobe at 13°.

### DETAILED DESCRIPTION OF THE INVENTION

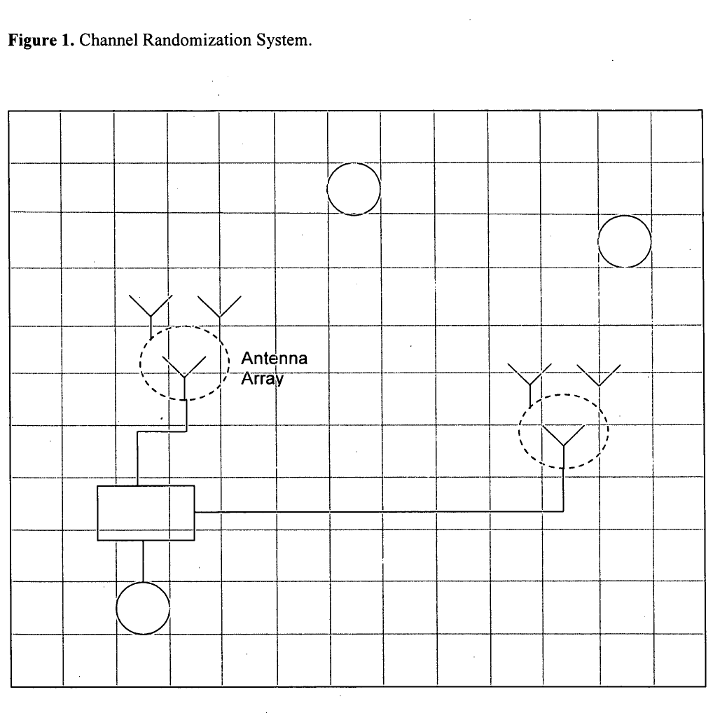

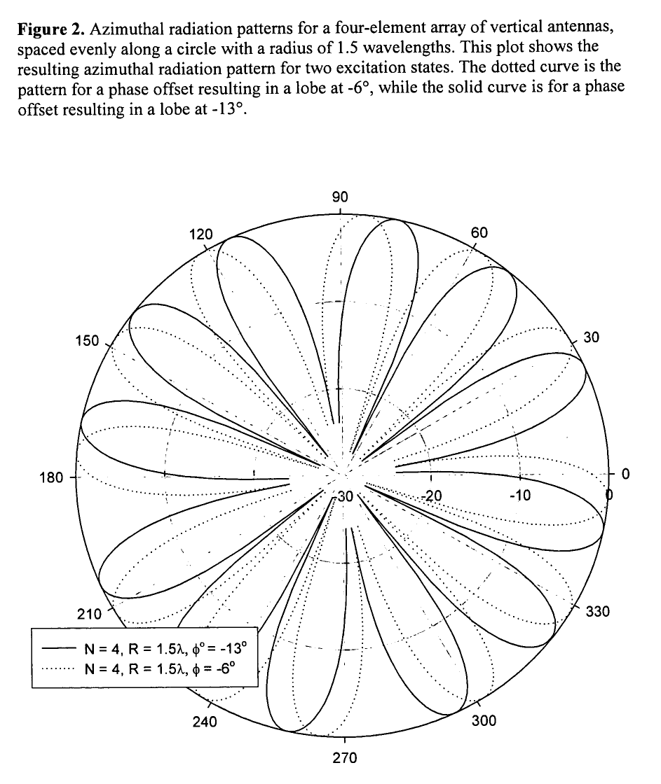

The following discussion sets forth examples of a novel encryption method that overcomes the limitations of conventional encryption methods in wireless networks, and is suitable for deployment in various wireless communication systems. Features of the invention, which are described below (with reference to FIGS. 1-2) include the following:

Introduction of Channel Randomization Systems: Referring to FIG. 1, in one of the embodiments of the invention, additional antennas are introduced to generate controllable radiation patterns. This antenna system, along with supporting circuitry and software, form the Channel Randomization System (CRS). The purpose of the CRS is to introduce bit errors into the communication signals from the Wireless Access Point (WAP) for all possible receivers in the wireless network. Receivers at different locations will receive frames with errors at different times. The CRS is designed and operated to guarantee that each receiver receives some keystream frames containing errors. The components of the CRS are described in greater detail below. The Channel Randomization System (CRS) and the wireless networking environment consist of the following components, as schematically depicted in FIG. 1:
1. A Wireless Access Point (WAP) or wireless user, A (Alice), who may send a secure keystream to user B (Bob);
2. A WAP or Wireless User Bob, who desires to receive a secure keystream from Alice;
3. An unauthorized user E (Eve) who desires to intercept the keystream transmission from Alice to Bob;
4. A CRS Controller, under the control of the wireless network management;
5. Two or more multiple element antenna arrays, located within the wireless network environment, and under the control of the CRS Controller;
6. A database of several (e.g., 10-100) antenna excitations, contained within the CRS Controller. These excitations are chosen such that there is at least one (preferably several) excitation that provides a radiation null at each grid square of the wireless network environment.
   The CRS is designed to generate location and time dependent bit errors for all receivers in the wireless network environment, which is described in more detail below.

Location and time dependent bit error generation: The Channel Randomization System (CRS) creates unrecoverable bit errors for eavesdroppers when they attempt to silently record the keystream. The CRS includes a set of antennas and the supporting circuitry and software. The CRS antennas deliver multiple stationary and/or rotating radiation patterns that interact with each other to create a distribution of radiation maximas and nulls in the space of the protected network. The design of the patterns ensures that the bit error bursts at different receivers occur at different keystream data frames. The differentiation of the bit error burst timing is guaranteed when the physical distance of the receivers exceeds a small and specified distance.

In one of the embodiments of the present invention the CRS antenna arrays are designed to have multi-lobed patterns that rotate in azimuth, under the control of the CRS Controller. An example of the azimuth radiation patterns for two different excitations is shown in FIG. 2. In this embodiment the antennas are used to periodically place pattern nulls (corresponding to signal levels well below the noise floor of the receiver system) at each location in the Wireless Local Area Network (WLAN) region, thus selectively inducing bit errors at different locations for different keystream frames.

In another embodiment of the present invention, a set of CRS antennas is used to selectively raise the noise or interference level at each location in the Wireless Local Area Network (WLAN) region to make such level well above the received signal level at the receiver, thus selectively inducing bit errors at different locations for different keystream frames.

In a further embodiment, the above schemes can be combined to effectively produce bit errors in keystream data for different locations at different times.

By altering the excitation phase of the elements of the array, the pattern can be made to rotate in the azimuthal plane. This can be done in very fine increments when desired, thus rotating the locations of beam maxima and beam nulls. So, for example, if it is determined that we need to reduce the Wireless LAN (WLAN) radio link margin by 20 dB, we see that the width of a null at the 20 dB level is about 7°, and this null repeats at least every 90° (the pattern has two-fold symmetry). Thus, if we rotate these patterns by 26 steps of 3.5° each over the transmission period of the keystream, we can guarantee that, at different times, each receiver will see at least one reduction in link margin of at least 20 dB, resulting in a high bit error rate during that pattern step. Note that it may also be desirable to employ power control at the transmitting Wireless Access Point (WAP) and/or raise the noise floor in the wireless network environment for optimal success in inducing bit errors over the desired coverage area.

It can be proven that the use of two or more arrays of this type introduces enough degrees of freedom so that it is possible to introduce nulls in the radiated signal power from the Wireless Access Point (WAP) at any grid location in a Wireless Local Area Network (WLAN) environment, and therefore to purposely generate significant bit errors in the transmission of the keystream to any and all receivers (both authorized and unauthorized). The authorized user, however, is able to request re-transmission (which will occur for a different antenna excitation, and therefore have different patterns nulls, thus allowing error-free transmission of the keystream to this user), while the unauthorized user will not be able to request re-transmission.

Operations of the CRS systems: In one of the embodiments of the CRS operation, the following procedure is followed.
1. Bob requests a secure transmission of a keystream from Alice;
2. Via the CRS controller, Alice resets her transmit power to a value near the minimum level required for error-free transmission to Bob. This can be done by monitoring the requests for re-transmission from Bob during a learning sequence.
3. Alice begins sending frames of the keystream to Bob, with the CRS Controller selecting different antenna excitations for different groups frame
4. Both Bob and Eve receive frames of keystream data, which may or may not have errors, depending on the antenna radiation pattern selected for that frame, and the locations of Bob and Eve. There are four possibilities:
   a. Bob receives no errors, Eve receives no errors: both record a valid frame of keystream data.
   b. Bob receives no errors, Eve receives errors: Eve cannot request frame re-transmission, and so loses integrity of the keystream data.
   c. Bob receives errors, Eve receives no errors: Bob requests re-transmission until he receives an error-free frame; This re-transmission is useless for Eve since she already has the correct frame;
   d. Bob receives errors, Eve receives errors: Bob requests re-transmission until he receives an error-free frame; Eve may be able to record the re-transmitted correct frame.
      The CRS is designed to guarantee that case b. happens frequently enough to prohibit Eve from recovering the integrity of her recorded keystream data.

Design of CRS radiation patterns: To illustrate further the above method, a concrete example setting is given below. Consider a wireless local area network covering a large (100×100 square feet) room with 200 cubicles and 250 computers. Each computer can be connected to the Wireless Access Point (WAP) via a Wireless Local Area Network (WLAN). In addition to the regular Wireless Access Point (WAP) antennas for sending and receiving communication signals, there are four additional Channel Randomization System (CRS) antennas that are designed to generate controllable bit error bursts for the receivers in the network. The CRS antennas are controlled by the CRS controller in the network management system and are used to deliver signals so that each authorized node receives the keystream from the Wireless Access Point (WAP) or other authorized users with bit error bursts at different frames.

Antenna radiation theory provides computation methods for generating the require radiation patterns given the network physical dimensions. Those skilled in the art will appreciate that the basic far field radiation formulas for a single antenna element or an antenna array can be used to solve for the excitation coefficients that will maximize or minimize the radiation power at any specific point in the space of the protected network. They will also appreciate that such formulas provide effective control functions for the antenna circuitry to achieve bit error generation at any specific point, and thus anywhere in the area of the protected network.

Use of reliable data link techniques for keystream transmission: Data link techniques can be used among authorized nodes in the network to provide reliable transmission of the keystreams. In one of the embodiments of the present invention the keystream at the sender node is divided into frames and error detection coding, such as Cyclic Redundancy Coding (CRC), is used to code the keystream frames before sending to the receiver. The authorized receiver nodes check the received frames and request re-transmission of frames with detected errors. On the other hand, receiver nodes that do not have the authorization from the sender nodes and/or the network management will not be able to fix the erroneous frames even if errors are detected. Those skilled in the art will appreciate that the current error detection and frame retransmission techniques provide extremely reliable data transfer in communication networks and can be used in the setting of the present invention to support reliable keystream transmission.

Trade off management of security vs. efficiency: The securely transmitted keystream is a valuable asset for the authorized communicating parties. It can serve many different security purposes. In general, different communication tasks may need different levels of security level. It is useful for the network management system to establish a set of Quality of Privacy (QoP) levels and let the user or application select the appropriate level of QoP to achieve an optimal tradeoff between privacy and efficiency. With the securely transmitted keystream there will be a spectrum of encryption methods available. Those skilled in encryption and network security will appreciate the value of the methods described in the present invention, which provides convenient and efficient means to transmit highly securely the keystreams.

### CONCLUSION

Those skilled in the art will appreciate that the methods and aspects of the present invention, as described by way of example herein and depicted in the attached drawings, can be implemented in hardware and software elements within conventional wireless networks or systems, by the exercise of known techniques of hardware design and software programming.

Those skilled in the art will also appreciate that the invention set forth above and described by way of example in the forgoing Detailed Description, taken in combination with the attached drawings and figures, provides significant advantage over prior art.

In particular, the methods described herein provide very strong encryption features for wireless networks or systems, thereby resulting in substantially stronger privacy and encryption against silent eavesdroppers in wireless network or systems than previous methods. The techniques presented herein offer a greater level of privacy and security in wireless networks than can be obtained with wired networks.

Also unique to the present invention is that it takes advantage of the error properties of the wireless channel, together with controlled disturbances, to generate selectable bit errors at selected points and time in a wireless network environment.

The foregoing embodiments and practices are described solely by way of example, and are not intended to limit the scope of the invention. Those skilled in the art will appreciate that numerous variations and modifications of the foregoing examples are possible and within the scope of the invention.

What is claimed as being new and desired to be protected is as follows:

1. A set of methods for the secure transmission of encryption keystreams, in the presence of an eavesdropper, over wireless channelsUse of additional antenna systems to selectively generate bit errors at different space locations and different times to achieve any of the said methods in 1.

2. Design of a Channel Randomization System and its controller to achieve any of the said methods in 1.

3. Use of error detection codes and re-transmission protocols to ensure correct transmission of keystreams among authorized nodes to achieve any of the said methods in 1.

4. Use of re-transmission request statistics for adaptively adjusting the Channel Randomization System speed and power to achieve any of the said methods in 1.

5. Everlasting privacy achieved with the use of securely transmitted random keystreams via any of the said methods in 1. for constructing the one-time pad;

6. Security against loss of private keys used to sample the random keystream securely transmitted via any of the said methods in 1.

7. Security superior to wired communication channel security against unauthorized silent eavesdroppers using any of the said methods in 1.

8. Any communication security enhancement achieved via any of the said methods in 1.
